(19) United States
(12) Patent Application Publication
(10) Pub. No.: US 2002/0067044 A1
(43) Pub. Date: Jun. 6, 2002

(54) Cover latch for dispenser apparatus

(76) Inventors: Zefu Chen, Greenacres, FL (US); James B. O'Maley, Lighthouse Pt, FL (US); Francis J. Parker, Cooper City, FL (US)

Correspondence Address: JAY H. MAIOLI, Cooper & Dunham LLP, 1185 Avenue of the Americas, New York, NY, 10036, US

(21) Appl. No.: 09/728,188

(22) Filed: Dec. 1, 2000

(51) Int. Cl. E05C 19/10

(52) U.S. Cl. 292/117

(57) ABSTRACT

A cover latch is used to secure a cover of a dispenser apparatus by engaging catches in the dispenser apparatus while being held in place by attached springs. The cover latch consists of a handle connected to a latch assembly through a rod. Pulling on the handle compresses the springs connected to the latch assembly and frees the latch assembly from catches in the dispenser apparatus. An O-ring on the rod seals the dispenser apparatus from contaminants.

### BACKGROUND OF THE INVENTION

1. Field of the Invention

The present invention relates to a cover latch for a dispenser apparatus. More particularly, this invention relates to a cover latch wherein a handle is pulled to disengage the latch in the dispenser so the cover may be opened.

2. Description of the Related Art

Dispenser units are often equipped with covers to allow easy access to refill the dispensers with a product to be dispensed or to perform service on the units. Various manufacturers design their dispensers with hinged covers, covers held in place with tabs, and the like.

A cover is often locked in place by suitable means to prevent theft or vandalism. A key lock holds a cover in place typically through use of a locking tab that rotates and engages a catch. These locks hold a cover firmly in place but have several disadvantages. The additional cost for a lock, however simple, can be significant when a large number of such locks are required. The locking tab is usually made of plastic instead of metal since dispensers are often placed in damp or wet environments and plastic, unlike metal, will not corrode. The plastic tabs, however, often bend or break after repeated use. The key is often metal, so it eventually wears the plastic keyhole after repeated use and the key no longer operates the lock. Moreover, the keyhole provides an entrance for water to infiltrate the unit and contaminate the dispenser mechanism or the product to be dispensed. Corresponding slots for the tabs are often cut into the dispenser body or cover, allowing water to enter and possibly contaminate the dispenser. Loss of a separate key is a common occurrence that may even lead to vandalism by maintenance personnel attempting to perform required maintenance.

Locking tabs that are molded into the body or cover of the dispenser unit may be used to keep the cover in place. Repeated flexing of these tabs due to repeated use often results in breaking or bending of the tabs. If these tabs break, the entire cover or body of the dispenser may need to be replaced to ensure proper locking of the dispenser. In addition, the surfaces of the body and cover of the dispenser unit are often scratched by various tools used by the refilling personnel to depress the tabs and pry the cover off. These tabs are usually located at the edges of the unit, which often face the wall or mounting surface, so that the entire unit must sometimes be removed from its mounting point in order to depress the tabs and perform required maintenance.

A cover latch mechanism may also be used to lock a dispenser cover in place. One existing latch mechanism shown in FIG. 1 utilizes a push bar 2 that is depressed by a user to disengage the latches 6 and unlock the cover. The latches 6 engage catches molded into the cover (not shown) to lock the cover in place. The push springs 4 bear against surfaces in the base of the dispenser (not shown). As the cover is closed, the catches formed in the cover contact and slide along the push latch ramps 8, the push springs 4 are compressed, and the latch mechanism moves into the body of the dispenser. When the catches clear the end of the push latch ramps 8, the push springs 4 expand and cause the latch mechanism to snap into the locked position. Fully depressing the push bar 2 into the dispenser disengages the push latch ramps 8 from the catches and allows the cover to be opened. The push latch ramps 8 are necessarily oriented toward the push bar 2 in order to allow them to disengage from the catches when the push bar 2 is depressed. Similarly, the push springs 4 are necessarily oriented away from the push bar 2 and toward the push latch ramps 8 in order to compress when the push bar 2 is depressed to disengage the latches 6.

This design has several disadvantages. In order to withstand the stress of pushing on the push bar 2 without simply bending and breaking in the middle, the latch mechanism must be molded of relatively thick plastic. This takes up more space than a thinner mechanism and adds weight and cost to the dispenser. The opening at the top of the dispenser that is necessary in order to accommodate the push bar 2 is a convenient way for water, dust and the like to contaminate the entire dispenser from the top down. This is a major concern in “touch-free” dispenser units, which employ battery powered electronics, sensors, motors and gears to dispense product. Furthermore, in order for the mechanism to function correctly the push bar 2 must be pushed into the dispenser body, which may be difficult for those with large hands and fingers.

### OBJECTS OF THE INVENTION

It is an object of the present invention to solve the problems discussed above relating to locking mechanisms for dispenser covers.

Specifically, it is an object of the present invention to provide a mechanism for opening a dispenser cover by pulling a handle.

In addition, it is an object of the present invention to provide a system for preventing water and other contaminants from entering a dispenser through a normal operation of the dispenser.

It is also an object of the present invention to allow greater design flexibility by using thinner parts to realize the dispenser mechanism.

### SUMMARY OF THE INVENTION

One embodiment of the present invention provides a cover latch for a dispenser comprising: a pull rod; a handle attached on one end to the pull rod; a support member attached to another end of the pull rod; a plurality of latches attached to the support member for engaging corresponding catches in the dispenser when the cover latch is in a locked position; and a plurality of springs attached to the support member for maintaining the cover latch in the locked position, wherein pulling the handle compresses the plurality of springs and disengages the plurality of latches from the catches. The cover latch further comprises an O-ring arranged around the pull rod to seal an opening in the dispenser through which the pull rod is pulled using the handle. The handle is attached at its center to the pull rod, and the pull rod has a circular cross section. The support member can be formed in a shape of a letter U, wherein the pull rod is attached to a center of a bottom of the U-shaped support member; the plurality of latches are attached to each arm of the U-shaped support member, oriented away from the pull rod; and the plurality of springs are attached to the bottom of the U-shaped support member, oriented toward the pull rod. The plurality of springs may be leaf springs. The plurality of latches include latch ramps that slide along the corresponding catches in the dispenser when a cover of the dispenser is being closed, thereby compressing the plurality of springs until the corresponding catches clear the latch ramps, thereby expanding the plurality of springs, moving the cover latch into the locked position and engaging the corresponding catches with the plurality of latches. The handle and the pull rod may be formed as a single unit. The support member, the plurality of latches and the plurality of springs may also be formed as a single unit.

### BRIEF DESCRIPTION OF THE DRAWINGS

FIG. 1 shows a latch mechanism found in the prior art;

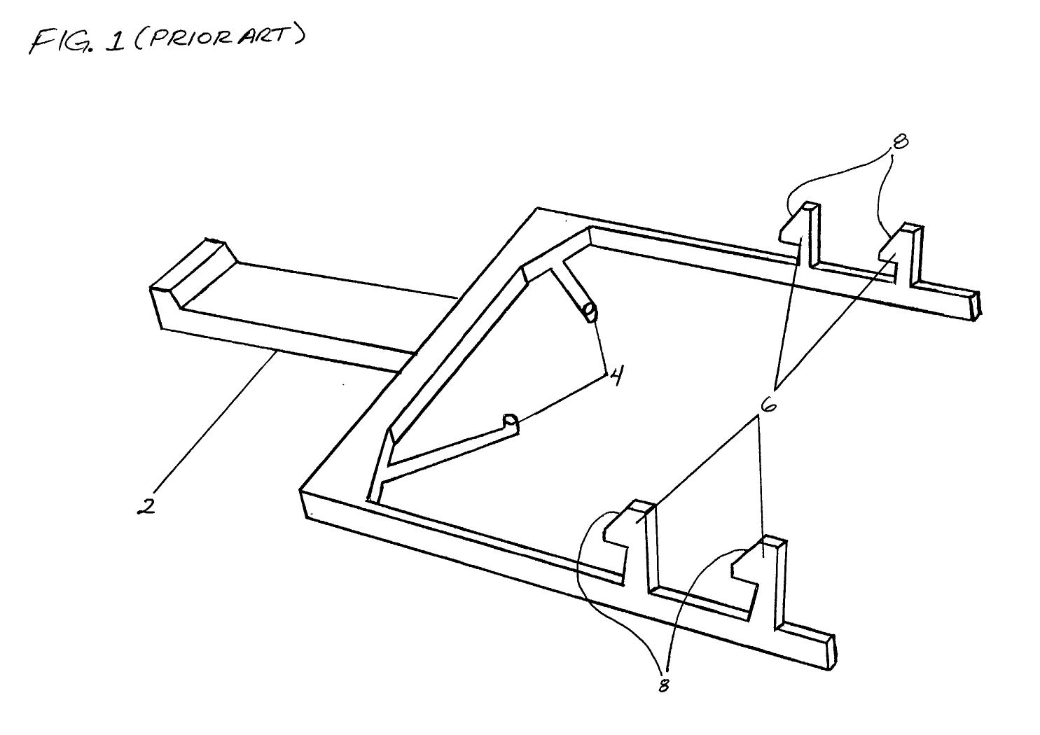

FIG. 2 shows a cutaway front view of a latch mechanism according to an embodiment of the present invention;

FIG. 3 shows a cutaway side view of the latch mechanism according to the embodiment of the present invention; and

FIG. 4 shows a cutaway front view of a dispenser apparatus employing the latch mechanism according to the embodiment of the present invention with a cover removed.

FIG. 5 shows a cutaway side view of a dispenser apparatus employing the latch mechanism according to the embodiment of the present invention.

### DETAILED DESCRIPTION OF THE PREFERRED EMBODIMENT

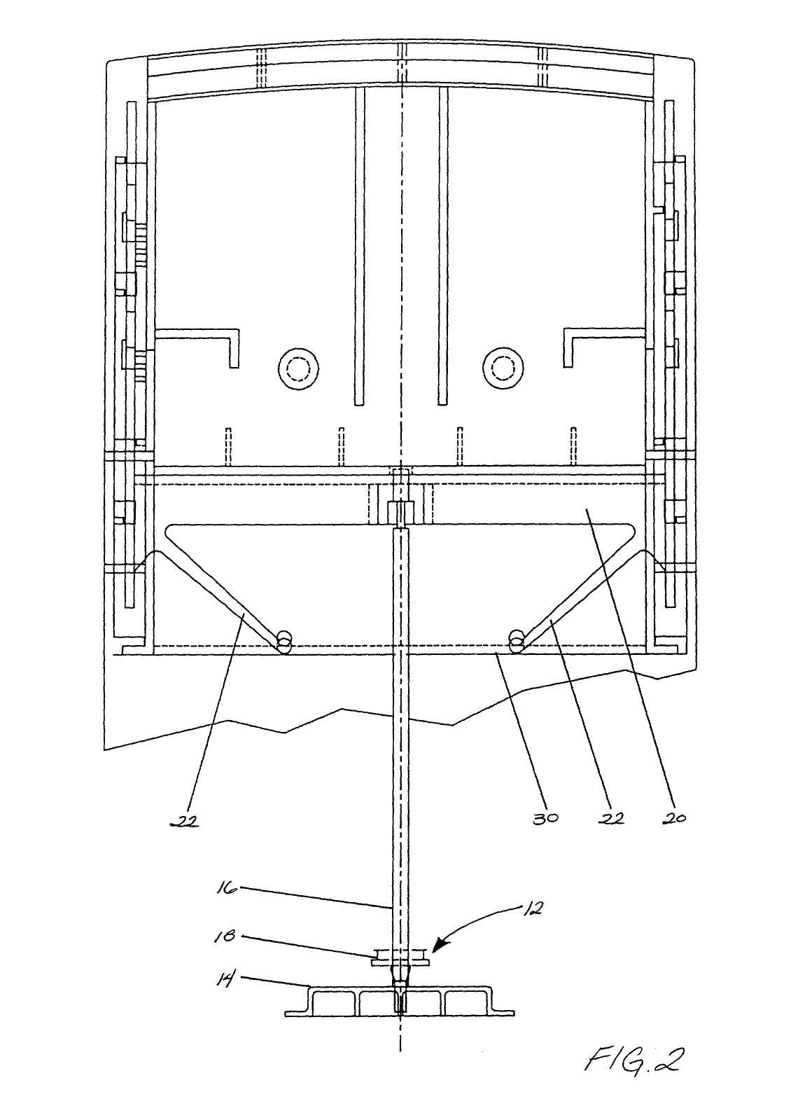

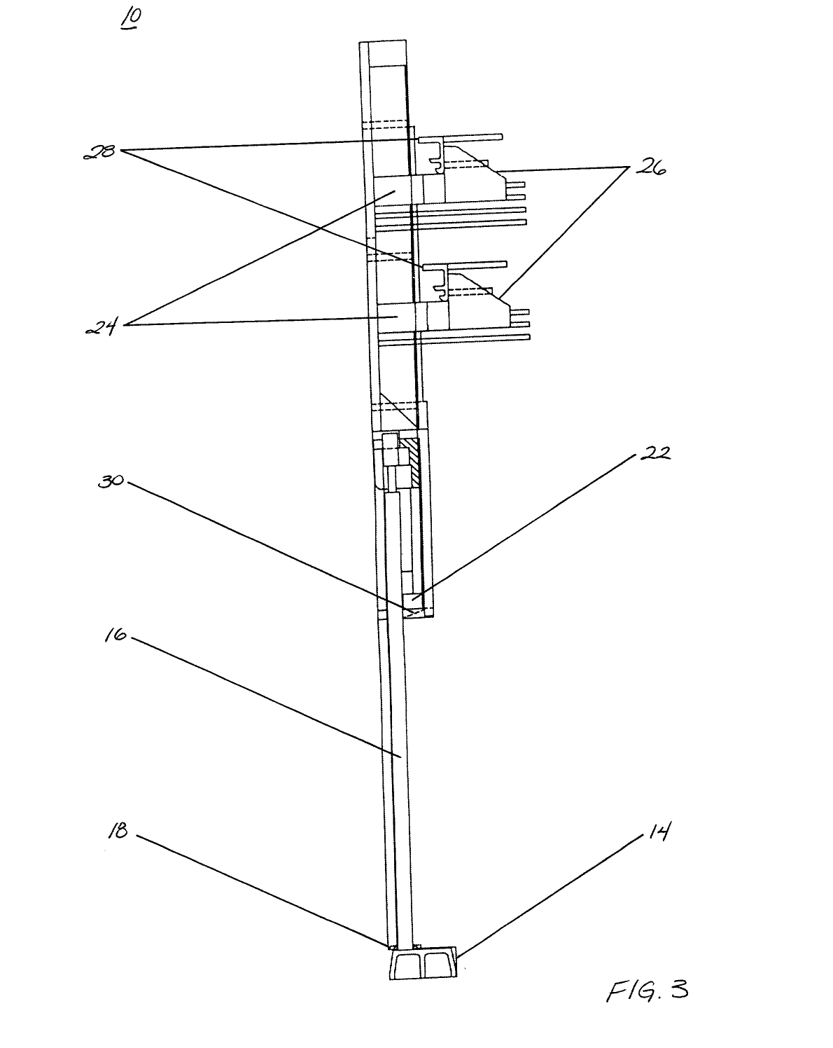

A preferred embodiment of a cover latch 10 for a dispenser is shown in FIG. 2 and FIG. 3. The cover latch 10 may be formed of plastic, metal or any material that has sufficient tensile strength per square inch to form a thin, lightweight assembly that resists deformation and breakage. The preferred embodiment is composed of two main molded plastic parts, a pull rod assembly 12 and a pull latch assembly 20. The two assemblies and their components may be molded as one unit, or separately formed and attached by being threaded together, snapping together or being held together by any fasteners that ensure the assemblies will not detach while in use.

The T-shaped pull rod assembly 12 consists of a handle 14 attached to a rod 16 with an O-ring 18 thereon. The handle 14 and rod 16 may be separate components or molded as one unit.

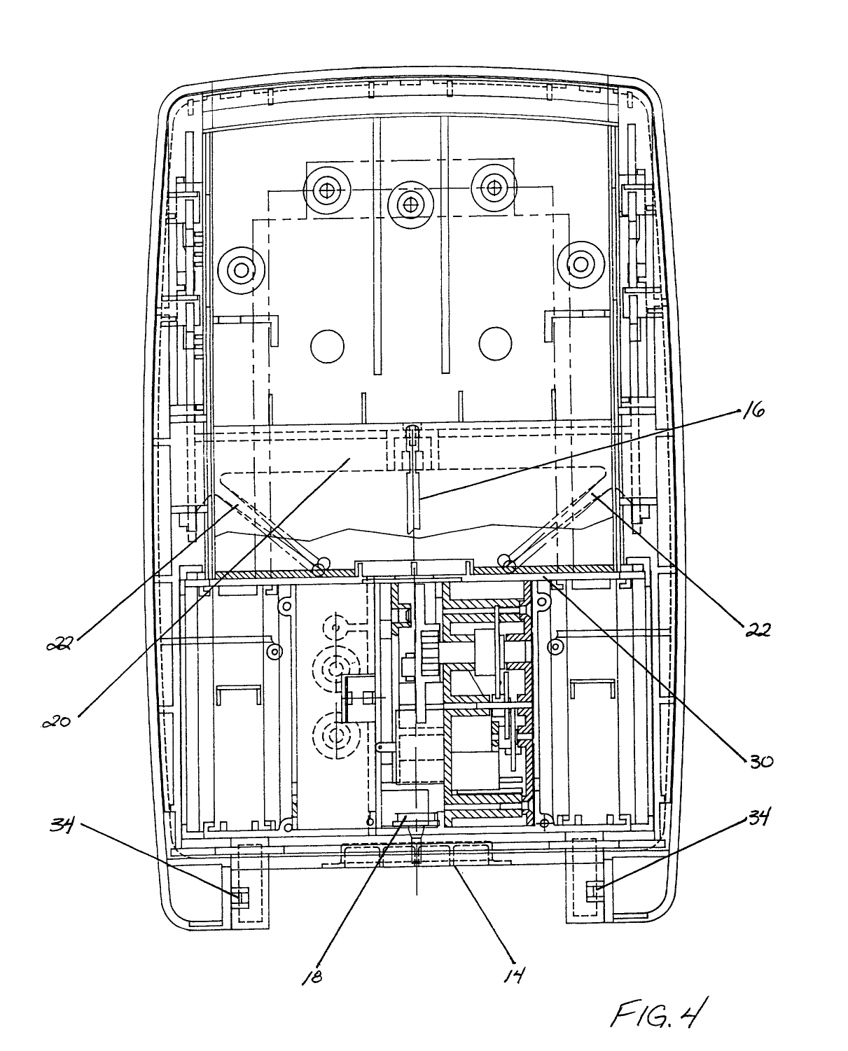

The handle 14 is ergonomically designed to allow a person to grasp it with a finger of each hand on either side of the rod 16 so as to apply an even pulling pressure. This reduces the stress on the entire cover latch assembly 10 and allows use of thinner materials for cost and weight savings, because thin materials can perform well in tension. The use of two hands also avoids inadvertent discharge of product from an automatic dispenser since neither hand need come within view of the dispenser triggering sensors. The handle 14 may be accessible through indentations or recesses molded into the body of the dispenser so it is essentially hidden from view in the normal mounting position of the dispenser, as shown in FIG. 4. Alternatively, the handle 14 may rest against the body of the dispenser, so it is visible but its function is not obvious to the casual observer. In both cases the handle 14 is held in place against the body of the dispenser by two springs 22, described below.

The rod 16 is preferably cylindrical to accommodate the O-ring 18, as well as for weight and space savings. The rod 16 may be threaded into the handle 14. Alternatively, the handle 14 and rod 16 may be molded as one unit that receives the O-ring 18 and may then be attached to the pull latch assembly 20. Use of a relatively thin rod 16 is possible since the rod 16 is in tension and need not to be so thick as to resist the compression caused by the force used if pushing on the handle were necessary to release the cover of the dispenser.

The O-ring 18 is used to prevent infiltration of water into the dispenser apparatus. It may be placed on a free end of the rod 16 during assembly before attaching the rod 16 to the pull latch assembly 20. Alternatively, the O-ring 18 may be placed on the free end of the rod 18 before attaching the handle 14 to the free end. The O-ring 18 is preferably positioned on the outside of the body of the dispenser in a small recess molded into the dispenser body to receive the O-ring 18 when the cover latch 10 is in the locked position. The O-ring 18 is held in compression against this recess by the springs 22 and thus prevents water or other contaminants to enter the dispenser when the cover is locked.

The U-shaped pull latch assembly 20 consists of springs 22 and latches 24 having latch ramps 26. The assembly may be attached to the rod 16 in the middle of the bottom of the “U” by any fastening means that ensures the two assemblies will not detach while in use. Alternatively, the two assemblies may be molded as one unit. The springs 22 and latches 24 may be separate components that attach to the pull latch assembly 20, but are preferably molded as one unit.

The springs 22 are shown in detail in FIG. 2 and FIG. 4. They are designed to keep the cover latch 10 in the locked position by bearing against a compression surface 34 molded or built into the dispenser. They are located on the bottom of the “U” and oriented toward the handle 12 and away from the latches 24. The springs 22 as shown are in the same plane as the pull latch assembly 20, but any angle may be used provided the compression surface 34 is correspondingly designed. Furthermore, the springs 22 as shown are leaf springs, but many different types of springs may be used with the same results.

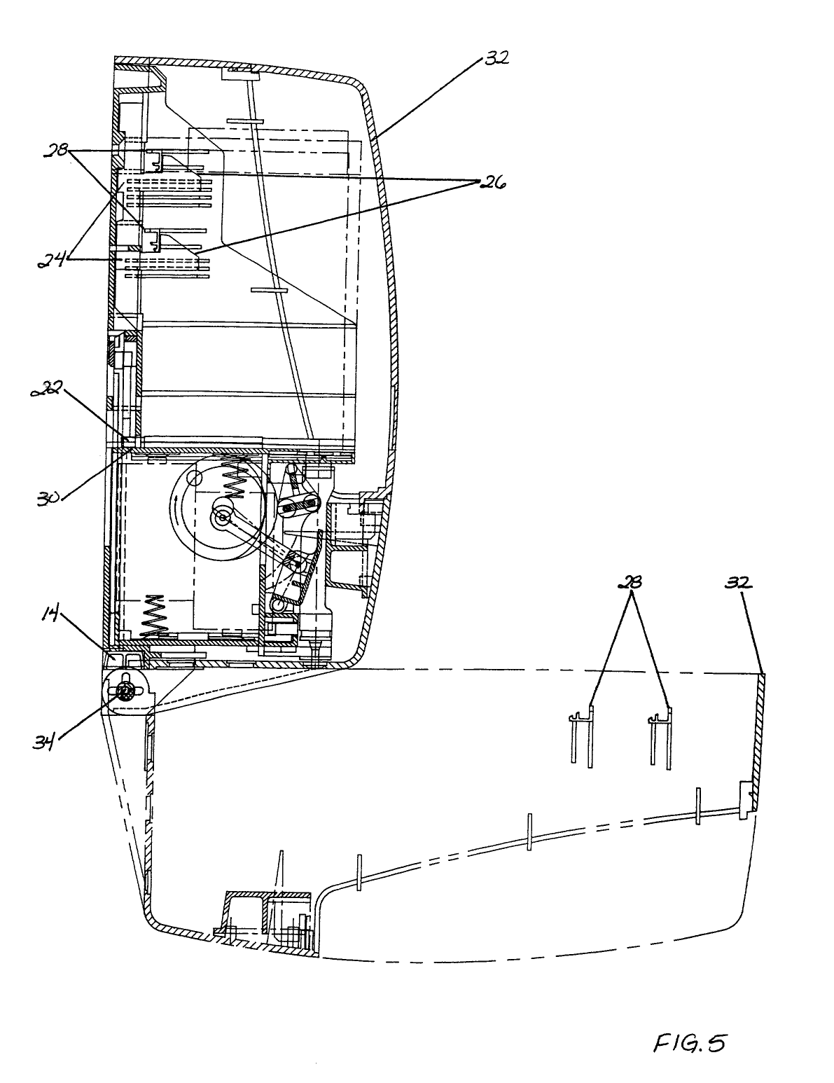

The latches 24 are located on either side on the “arms” of the U-shaped pull latch assembly 20 as shown in FIG. 3. They are oriented so that the latch ramps 26 face away from the bottom of the “U” and the pull rod assembly 12. The latches 24 engage catches 28 in the cover 32 to lock it in place when closed as shown in FIG. 3 and FIG. 5. The latches 24 as shown in the preferred embodiment are placed at right angles on the pull latch assembly 20. Alternatively, the latches 24 may be placed inside or outside of the “arms” of the U-shaped pull latch assembly 20, on the same plane as the rest of the assembly, with the same results. This would require a sliding cover but would operate in a manner similar to that of the preferred embodiment.

An opening and closing operation using the cover latch 10 will now be described with reference to FIG. 4 and FIG. 5, which depict a representative dispenser apparatus. The cover latch 10 removably slides along channels in the base of the dispenser. When the cover 32 of the dispenser is being closed by rotating on hinges 34 on either side of the handle 14, the latch ramps 26 of the latches 24 contact the catches 28 in the cover. The catches 28 slide along the surfaces of the latch ramps 26, compressing the springs 22 against the compression surface 34 of the dispenser. At the same time this moves the cover latch 10 downward so that the handle projects out of the body of the dispenser. When the catches 28 clear the end of the latch ramps 26, the springs 22 expand and move the cover latch 10 into the locked position, drawing the handle 14 against the dispenser body.

It should be noted that the cover may be entirely removable, or attached to the housing via a hinge, or the like. The dispenser in FIG. 4 and FIG. 5 features a hinged cover, but the cover latch 10 is equally effective with non-hinged covers. For example, the hinges 28 may be replaced by a slot designed to support the cover by receiving a tab molded onto the cover, allowing the cover to then be locked in place by the cover latch 10 as above.

In order to open the cover 32, a person simply pulls the handle 14 away from the dispenser body. The springs 22 are compressed against the compression surface 34 and the latches 24 disengage the catches 28. The cover 32 may then be swung open as shown in FIG. 5. The cover latch 10 returns to the locked position when the handle 14 is released, causing the springs 22 to expand.

The cover latch 10 in the preferred embodiment is oriented so that the handle 14 is at the bottom of the dispenser and does not interfere with the cover 32 opening and closing, or the operation of the hinges 34. It is possible to design the dispenser so the handle 14 is operable from the side, front or the top of the dispenser, so long as the orientation of the latches are also repositioned accordingly. The cover latch 10 would still operate by pulling the handle 14 to open the cover. The thin and lightweight design of the cover latch 10 allows greater overall flexibility in designing a dispenser with numerous parts and improved features such as greater product storage and electronics to operate the dispenser. The cover latch 10 may also be designed to removably slide in the cover and engage catches molded into the base.

The above invention has been described with specific embodiments, but a person skilled in the art could introduce many variations on these embodiments without departing from the spirit of the disclosure or from the scope of the appended claims. The embodiments are presented for the purpose of illustration only and should not be read as limiting the invention or its application. Therefore, the claims should be interpreted commensurate with the spirit and scope of the invention.

We claim:

1. A cover latch for a dispenser comprising:
a pull rod;
a handle attached on one end to said pull rod;
a support member attached to another end of said pull rod;
a plurality of latches attached to said support member for engaging corresponding catches in the dispenser when said cover latch is in a locked position; and
a plurality of springs attached to said support member for maintaining said cover latch in the locked position, wherein pulling said handle compresses said plurality of springs and disengages said plurality of latches from the catches.

2. The cover latch as set forth in claim 1, further comprising:
an O-ring arranged around said pull rod to seal an opening in the dispenser through which said pull rod is pulled using said handle.

3. The cover latch as set forth in claim 1, wherein
said handle is attached at its center to said pull rod.

4. The cover latch as set forth in claim 1, wherein
said pull rod has a circular cross section.

5. The cover latch as set forth in claim 1, wherein
said support member is formed in a shape of a letter U.

6. The cover latch as set forth in claim 5, wherein
said pull rod is attached to a center of a bottom of said U-shaped support member;
said plurality of latches are attached to each arm of said U-shaped support member, oriented away from said pull rod; and
said plurality of springs are attached to the bottom of said U-shaped support member, oriented toward said pull rod.

7. The cover latch as set forth in claim 1, wherein
said plurality of springs are leaf springs.

8. The cover latch as set forth in claim 1, wherein
said plurality of latches include latch ramps that slide along the corresponding catches in the dispenser when a cover of the dispenser is being closed, thereby compressing the plurality of springs until the corresponding catches clear the latch ramps, thereby expanding the plurality of springs, moving the cover latch into the locked position and engaging the corresponding catches with said plurality of latches.

9. The cover latch as set forth in claim 1, wherein
said handle and said pull rod are formed as a single unit.

10. The cover latch as set forth in claim 1, wherein
said support member, said plurality of latches and said plurality of springs are formed as a single unit.
